(19) United States
(12) Patent Application Publication
(10) Pub. No.: US 2013/0100307 A1
(43) Pub. Date: Apr. 25, 2013

(54) METHODS, APPARATUSES AND COMPUTER PROGRAM PRODUCTS FOR ANALYZING CONTEXT-BASED MEDIA DATA FOR TAGGING AND RETRIEVAL

(71) Applicants: Igor Danilo Diego CURCIO, Tampere (FI); Sujeet Shyamsundar MATE, Tampere (FI); Kostadin DABOV, Tampere (FI); Francesco CRICRI, Tampere (FI)

(72) Inventors: Igor Danilo Diego CURCIO, Tampere (FI); Sujeet Shyamsundar MATE, Tampere (FI); Kostadin DABOV, Tampere (FI); Francesco CRICRI, Tampere (FI)

(73) Assignee: Nokia Corporation, Espoo (FI)

(21) Appl. No.: 13/281,161

(22) Filed: Oct. 25, 2011

(51) Int. Cl. H04N 5/228

(52) U.S. Cl. 348/222.1; 348/E05.031

(57) ABSTRACT

An apparatus for enabling retrieval of media content and identifying an interestingness of the media content may include a processor and memory storing executable computer program code that cause the apparatus to at least perform operations including capturing items of media content including objects and assigning context data indicating a determined location of one of the captured objects and a time that the object was captured to the media content. The computer program code may further cause the apparatus to assign a detected item of orientation information indicating an orientation of a media capturing device, capturing the objects, to the context data associated with the media content. The computer program code may further cause the apparatus to enable retrieval of the media content from a memory based on analyzing the location of the captured object, the time and the orientation information. Corresponding methods and computer program products are also provided.

### TECHNOLOGICAL FIELD

Embodiments of the present invention relate generally to media content events and, more particularly, relate to a method, apparatus, and computer program product for utilizing context data associated with the media content events to retrieve the corresponding media content and determine data of interest in the media content.

### BACKGROUND

At public events, such as concerts, theater performances and/or sports, it is increasingly popular for users to capture these public events using a camera and then store the captured events as media content events, such as an image, a video, an audio recording and/or the like. These captured media content events are even more frequently captured by a camera or other image capturing device attached to a mobile terminal, and may be stored for future access. are saved for future consideration. However, due to the large quantity of public events and the large number of mobile terminals, a number of media content events may be unclassified and may never be matched to a particular media event type. As such, it may be difficult to identify and retrieve captured media content events related to public events such as, for example, video recordings which are likely to contain one or more objects (e.g., a person or any other object) in view of a camera.

### BRIEF SUMMARY

A method, apparatus and computer program product are therefore provided according to an example embodiment of the present invention to analyze different aspects of a public event captured by a plurality of cameras (e.g., image capture device; video recorder and/or the like) and stored as media content events to enable retrieval of the media content in an efficient and reliable manner. In this regard, sensor (e.g., multimodal) data, including but not limited to, data captured by a visual sensor, an audio sensor, a compass, an accelerometer, a gyroscope and/or a global positioning system receiver and stored in the media content events and/or received through other means may be used to retrieve media data of captured public events.

The method, apparatus and computer program product according to an example embodiment may also be configured to determine interesting video views based on motion activity of objects captured in media content events. For instance, an example embodiment of the invention may also enable detection of an interesting video view based on motion activity of objects (e.g., people) which may be inside the field of view of a camera (e.g., a camera module). As an example, interesting views may be views that include people who are dancing, clapping, jumping in a specific rhythm or performing any other suitable interesting actions or functions. An example embodiment may detect sensor data from communication devices that may not be recording any media content and may utilize this detected sensor data to determine interesting views of an image(s) or video(s).

Moreover, an example embodiment may exploit sensor data to detect orientation (e.g., horizontal and/or vertical orientation) of multiple users and may take into account the angle of view of a recording device(s) (e.g., a camera) to detect if an object(s) for which location information is available is within the field of view of a video or image recording(s).

In addition, an example embodiment may also enable real-time communication of a recording communication device and a network device such as, for example, a server that may provide information of the location of potentially interesting objects based on motion activity of the objects.

In one example embodiment, a method for enabling retrieval of media content and determining whether a portion of media content is interesting is provided. The method may include capturing one or more items of media content including one or more objects and assigning context data indicating at least one determined location of at least one of the captured objects and a time that the object was captured to the media content. The method may further include assigning a detected item of orientation information indicating an orientation of a media capturing device capturing the objects to the context data associated with the media content. The method may further include enabling retrieval of the media content from a memory based in part on analyzing the location of the captured object, the time and the orientation information.

In another example embodiment, an apparatus for enabling retrieval of media content and determining whether a portion of media content is interesting is provided. The apparatus may include a processor and a memory including computer program code. The memory and the computer program code are configured to, with the processor, cause the apparatus to perform operations including capturing one or more items of media content including one or more objects and assigning context data indicating at least one determined location of at least one of the captured objects and a time that the object was captured to the media content. The memory and the computer program code may further cause the apparatus to assign a detected item of orientation information indicating an orientation of a media capturing device capturing the objects to the context data associated with the media content. The memory and the computer program code may further cause the apparatus to enable retrieval of the media content from a memory based in part on analyzing the location of the captured object, the time and the orientation information.

In another example embodiment, a computer program product for enabling retrieval of media content and determining whether a portion of media content is interesting is provided. The computer program product includes at least one computer-readable storage medium having computer executable program code instructions stored therein. The computer executable program code instructions may include program code instructions configured to enable capturing one or more items of media content including one or more objects and assigning context data indicating at least one determined location of at least one of the captured objects and a time that the object was captured to the media content. The program code instructions may also be configured to assign a detected item of orientation information indicating an orientation of a media capturing device capturing the objects to the context data associated with the media content. The program code instructions may also be configured to enable retrieval of the media content from a memory based in part on analyzing the location of the captured object, the time and the orientation information.

In another example embodiment, an apparatus for enabling retrieval of media content and determining whether a portion of media content is interesting is provided. The apparatus may include means for capturing one or more items of media content including one or more objects and assigning context data indicating at least one determined location of at least one of the captured objects and a time that the object was captured to the media content. The apparatus may also include means for assigning a detected item of orientation information indicating an orientation of a media capturing device capturing the objects to the context data associated with the media content. The apparatus may also include means for enabling retrieval of the media content from a memory based in part on analyzing the location of the captured object, the time and the orientation information.

In another example embodiment, a method for enabling retrieval of media content and determining whether a portion of media content is interesting is provided. The method may include receiving one or more captured items of media content including one or more objects from one or more media capturing devices of one or more corresponding sensor-enabled devices and assigning context data indicating one or more determined locations of the captured objects and times that the objects were captured to corresponding items of the media content. The method may also include assigning corresponding detected items of orientation information indicating respective orientations of the media capturing devices capturing the objects to the context data associated with the media content. The method may also include enabling retrieval of at least one corresponding item of the media content from a memory. The retrieval may be based in part on analyzing a corresponding determined location of at least one of the captured objects, a corresponding time the object was captured and corresponding orientation information denoting an orientation in which a respective media capturing device captured the object.

In another example embodiment, an apparatus for enabling retrieval of media content and determining whether a portion of media content is interesting is provided. The apparatus may include a processor and a memory including computer program code. The memory and the computer program code are configured to, with the processor, cause the apparatus to at least perform operations including receiving one or more captured items of media content including one or more objects from one or more media capturing devices of one or more corresponding sensor-enabled devices and assigning context data indicating one or more determined locations of the captured objects and times that the objects were captured to corresponding items of the media content. The memory and the computer program code may further cause the apparatus to may assign corresponding detected items of orientation information indicating respective orientations of the media capturing devices capturing the objects to the context data associated with the media content. The memory and the computer program code may further cause the apparatus to enable retrieval of at least one corresponding item of the media content from a memory. The retrieval may be based in part on analyzing a corresponding determined location of at least one of the captured objects, a corresponding time the object was captured and corresponding orientation information denoting an orientation in which a respective media capturing device captured the object.

In another example embodiment, a computer program product for enabling retrieval of media content and determining whether a portion of media content is interesting is provided. The computer program product includes at least one computer-readable storage medium having computer executable program code instructions stored therein. The computer executable program code instructions may include program code instructions configured to facilitate receipt of one or more captured items of media content including one or more objects from one or more media capturing devices of one or more corresponding sensor-enabled devices and assigning context data indicating one or more determined locations of the captured objects and times that the objects were captured to corresponding items of the media content. The program code instructions may also assign corresponding detected items of orientation information indicating respective orientations of the media capturing devices capturing the objects to the context data associated with the media content. The program code instructions may also enable retrieval of at least one corresponding item of the media content from a memory. The retrieval may be based in part on analyzing a corresponding determined location of at least one of the captured objects, a corresponding time the object was captured and corresponding orientation information denoting an orientation in which a respective media capturing device captured the object.

In another example embodiment, an apparatus for enabling retrieval of media content and determining whether a portion of media content is interesting is provided. The apparatus may include means for receiving one or more captured items of media content including one or more objects from one or more media capturing devices of one or more corresponding sensor-enabled devices and assigning context data indicating one or more determined locations of the captured objects and times that the objects were captured to corresponding items of the media content. The apparatus may also include means for assigning corresponding detected items of orientation information indicating respective orientations of the media capturing devices capturing the objects to the context data associated with the media content. The apparatus may also include means for enabling retrieval of at least one corresponding item of the media content from a memory. The retrieval may be based in part on analyzing a corresponding determined location of at least one of the captured objects, a corresponding time the object was captured and corresponding orientation information denoting an orientation in which a respective media capturing device captured the object.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic block diagram of a system according to an example embodiment of the invention;

FIG. 2 is a schematic block diagram of an apparatus according to an example embodiment of the invention;

FIG. 3 is a schematic block diagram of a network device according to an example embodiment of the invention;

FIG. 4 is a schematic block diagram of a system according to an example embodiment of the invention;

FIG. 5 is a diagram illustrating objects that are within a field of view of a camera module according to an example embodiment of the invention;

FIG. 6 is a diagram illustrating captured objects and the recording devices with coordinates according to an example embodiment of the invention;

FIG. 7A is a diagram illustrating the presence of objects with sensor data indicating desired movement in the field of view of a media capturing device with high confidence;

FIG. 7B is a diagram illustrating the presence of objects with sensor data indicating desired movement in the field of view of a media capturing device with low confidence;

FIG. 8 is a flowchart of an example method of enabling retrieval of captured media content and determination of an interestingness of the media content according to an example embodiment of the invention; and

FIG. 9 is a flowchart of another example method of enabling retrieval of captured media content and determination of an interestingness of the media content according to an example embodiment of the invention.

### DETAILED DESCRIPTION

Some embodiments of the invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the invention. Moreover, the term “exemplary”, as used herein, is not provided to convey any qualitative assessment, but instead merely to convey an illustration of an example. Thus, use of any such terms should not be taken to limit the spirit and scope of embodiments of the invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory, physical or tangible storage medium (e.g., volatile or non-volatile memory device), may be differentiated from a “computer-readable transmission medium,” which refers to an electromagnetic signal.

In some example embodiments, mobile terminals capable of capturing video, detecting locations and orientation in space, as well as connecting to a network may be utilized at one or more public events. The mobile terminals may include a camera(s) and may also be equipped with multiple sensors that may be utilized to assist in contextualizing the manner in which a communication device is used. According to an example embodiment, by utilizing network (e.g., Internet) connectivity and sensor information, a mobile terminal may enable user generated content by multiple users at a public event to be utilized for a variety of purposes. In this regard, some example embodiments may exploit context information recorded from mobile terminals in order to enrich video content captured by such mobile terminals and may enable various applications of the captured context data even in instances in which the captured context data does not include video content.

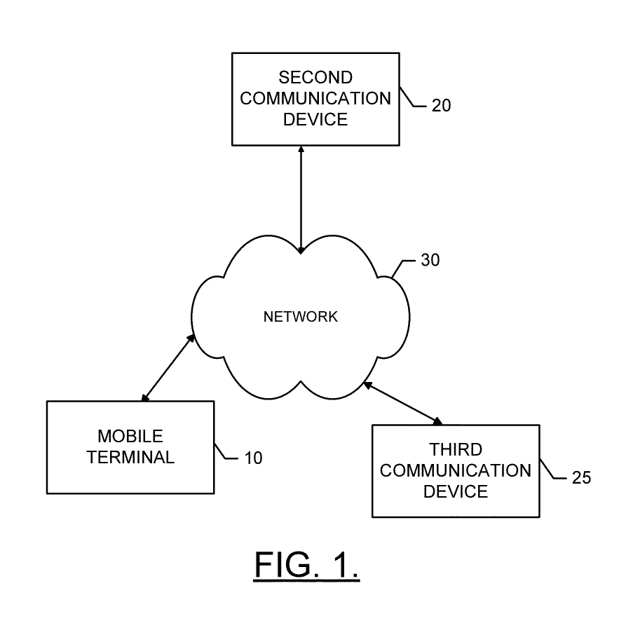

FIG. 1 illustrates a generic system diagram in which a device such as a mobile terminal 10 is shown in an example communication environment. As shown in FIG. 1, an embodiment of a system in accordance with an example embodiment of the invention may include a first communication device (e.g., mobile terminal 10) and a second communication device 20 capable of communication with each other via a network 30. In some cases, an embodiment of the present invention may further include one or more additional communication devices, one of which is depicted in FIG. 1 as a third communication device 25. In one embodiment, not all systems that employ an embodiment of the present invention may comprise all the devices illustrated and/or described herein. While an embodiment of the mobile terminal 10 and/or second and third communication devices 20 and 25 may be illustrated and hereinafter described for purposes of example, other types of terminals, such as portable digital assistants (PDAs), tablets, pagers, mobile televisions, mobile telephones, gaming devices, laptop computers, cameras, video recorders, audio/video players, radios, global positioning system (GPS) devices, Bluetooth headsets, Universal Serial Bus (USB) devices or any combination of the aforementioned, and other types of voice and text communications systems, can readily employ an embodiment of the present invention. Furthermore, devices that are not mobile, such as servers and personal computers may also readily employ an embodiment of the present invention.

The network 30 may include a collection of various different nodes (of which the second and third communication devices 20 and 25 may be examples), devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in one embodiment, the network 30 may be capable of supporting communication in accordance with any one or more of a number of First-Generation (1G), Second-Generation (2G), 2.5G, Third-Generation (3G), 3.5G, 3.9G, Fourth-Generation (4G) mobile communication protocols, Long Term Evolution (LTE) or Evolved Universal Terrestrial Radio Access Network (E-UTRAN), Self Optimizing/Organizing Network (SON) intra-LTE, inter-Radio Access Technology (RAT) Network and/or the like. In one embodiment, the network 30 may be a peer-to-peer (P2P) network.

One or more communication terminals such as the mobile terminal 10 and the second and third communication devices 20 and 25 may be in communication with each other via the network 30 and each may include an antenna or antennas for transmitting signals to and for receiving signals from one or more base sites. The base sites could be, for example one or more base stations (BS) that is a part of one or more cellular or mobile networks or one or more access points (APs) that may be coupled to a data network, such as a Local Area Network (LAN), Wireless Local Area Network (WLAN), a Metropolitan Area Network (MAN), and/or a Wide Area Network (WAN), such as the Internet. In turn, other devices such as processing elements (e.g., personal computers, server computers or the like) may be coupled to the mobile terminal 10 and the second and third communication devices 20 and 25 via the network 30. By directly or indirectly connecting the mobile terminal 10 and the second and third communication devices 20 and 25 (and/or other devices) to the network 30, the mobile terminal 10 and the second and third communication devices 20 and 25 may be enabled to communicate with the other devices or each other. For example, the mobile terminal 10 and the second and third communication devices 20 and 25 as well as other devices may communicate according to numerous communication protocols including Hypertext Transfer Protocol (HTTP), Real-time Transport Protocol (RTP), Session Initiation Protocol (SIP), Real Time Streaming Protocol (RTSP) and/or the like, to thereby carry out various communication or other functions of the mobile terminal 10 and the second and third communication devices 20 and 25, respectively.

Furthermore, although not shown in FIG. 1, the mobile terminal 10 and the second and third communication devices 20 and 25 may communicate in accordance with, for example, Radio Frequency (RF), Near Field Communication (NFC), Bluetooth (BT), Infrared (IR) or any of a number of different wireline or wireless communication techniques, including Local Area Network (LAN), Wireless LAN (WLAN), Worldwide Interoperability for Microwave Access (WiMAX), Wireless Fidelity (Wi-Fi), Ultra-Wide Band (UWB), Wibree techniques and/or the like. As such, the mobile terminal 10 and the second and third communication devices 20 and 25 may be enabled to communicate with the network 30 and each other by any of numerous different access mechanisms. For example, mobile access mechanisms such as Wideband Code Division Multiple Access (W-CDMA), CDMA2000, Global System for Mobile communications (GSM), General Packet Radio Service (GPRS) and/or the like may be supported as well as wireless access mechanisms such as WLAN, WiMAX, and/or the like and fixed access mechanisms such as Digital Subscriber Line (DSL), cable modems, Ethernet and/or the like.

In an example embodiment, the first communication device (e.g., the mobile terminal 10) may be a mobile communication device such as, for example, a wireless telephone or other devices such as a personal digital assistant (PDA), mobile computing device, camera, video recorder, audio/video player, positioning device, game device, television device, radio device, or various other like devices or combinations thereof. The second communication device 20 and the third communication device 25 may be mobile or fixed communication devices. However, in one example, the second communication device 20 and the third communication device 25 may be servers, remote computers or terminals such as personal computers (PCs) or laptop computers.

In an example embodiment, the network 30 may be an ad hoc or distributed network arranged to be a smart space. Thus, devices may enter and/or leave the network 30 and the devices of the network 30 may be capable of adjusting operations based on the entrance and/or exit of other devices to account for the addition or subtraction of respective devices or nodes and their corresponding capabilities.

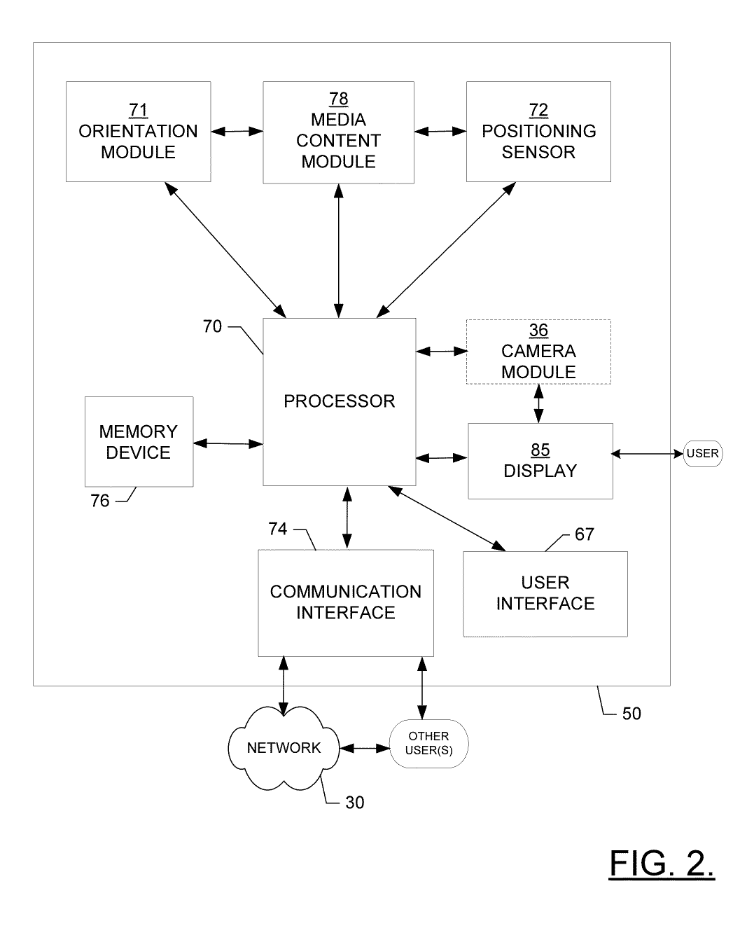

In an example embodiment, the mobile terminal 10 as well as the second and third communication devices 20 and 25 may employ an apparatus (e.g., apparatus of FIG. 2) capable of employing an embodiment of the invention. In one example embodiment, the second communication device 20 may be a network device such as, for example, a server and the third communication device 25 may be a sensor-enabled device. The sensor-enabled device may detect motion activity (e.g., via gyroscopes, accelerometers, etc.) of the sensor-enabled device. In an instance in which the sensor-enabled device is being captured in the field of view of a media capturing element (e.g., a camera (e.g., camera module 36 of FIG. 2)) of the mobile terminal 10, the sensor-enabled device may provide the motion activity information (e.g., motion measurements) to the mobile terminal 10 either directly or via the second communication device 20 (e.g., the network device). The mobile terminal 10 may utilize the motion activity information in part for retrieval of associated media content (e.g., an image(s), video(s)), and/or determining an interesting segment of the media content or for any other suitable reasons.

FIG. 2 illustrates a schematic block diagram of an apparatus according to an example embodiment. An example embodiment of the invention will now be described with reference to FIG. 2, in which certain elements of an apparatus 50 are displayed. The apparatus 50 of FIG. 2 may be employed, for example, on the mobile terminal 10 (and/or the second communication device 20 or the third communication device 25). Alternatively, the apparatus 50 may be embodied on a network device of the network 30. However, the apparatus 50 may alternatively be embodied at a variety of other devices, both mobile and fixed (such as, for example, any of the devices listed above). In some cases, an embodiment may be employed on a combination of devices. Accordingly, one embodiment of the invention may be embodied wholly at a single device (e.g., the mobile terminal 10), by a plurality of devices in a distributed fashion (e.g., on one or a plurality of devices in a P2P network) or by devices in a client/server relationship. Furthermore, it should be noted that the devices or elements described below may not be mandatory and thus some may be omitted in a certain embodiment.

Referring now to FIG. 2, the apparatus 50 may include or otherwise be in communication with a processor 70, a user interface 67, a communication interface 74, a memory device 76, a display 85, an orientation module 71, a media content module 78, a positioning sensor 72 and optionally a camera module 36. In one example embodiment, the display 85 may be a touch screen display. The memory device 76 may include, for example, volatile and/or non-volatile memory. For example, the memory device 76 may be an electronic storage device (e.g., a computer readable storage medium) comprising gates configured to store data (e.g., bits) that may be retrievable by a machine (e.g., a computing device like processor 70). In an example embodiment, the memory device 76 may be a tangible memory device that is not transitory. The memory device 76 may be configured to store information, data, files, applications, instructions or the like for enabling the apparatus to carry out various functions in accordance with an example embodiment of the invention. For example, the memory device 76 could be configured to buffer input data for processing by the processor 70. Additionally or alternatively, the memory device 76 could be configured to store instructions for execution by the processor 70. As yet another alternative, the memory device 76 may be one of a plurality of databases that store information and/or media content (e.g., pictures, images, videos, audio data, etc.).

The memory device 76 may store geocoded information that may be associated with location information corresponding to coordinates such as, for example, latitude, longitude and/or altitude coordinates of objects (e.g., real world objects). The geocoded information may be evaluated by the processor 70 and/or media content module 78 and data associated with the geocoded information may be provided to a camera view of a display (e.g., display 85).

The apparatus 50 may, in one embodiment, be a mobile terminal (e.g., mobile terminal 10) or a fixed communication device or computing device configured to employ an example embodiment of the invention. However, in one embodiment, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement an embodiment of the invention on a single chip or as a single “system on a chip.” As such, in some cases, a chip or chipset may constitute means for performing one or more operations for providing the functionalities described herein. Additionally or alternatively, the chip or chipset may constitute means for enabling user interface navigation with respect to the functionalities and/or services described herein.

The processor 70 may be embodied in a number of different ways. For example, the processor 70 may be embodied as one or more of various processing means such as a coprocessor, microprocessor, a controller, a digital signal processor (DSP), processing circuitry with or without an accompanying DSP, or various other processing devices including integrated circuits such as, for example, an ASIC (application specific integrated circuit), an FPGA (field programmable gate array), a microcontroller unit (MCU), a hardware accelerator, a special-purpose computer chip, or the like. In an example embodiment, the processor 70 may be configured to execute instructions stored in the memory device 76 or otherwise accessible to the processor 70. As such, whether configured by hardware or software methods, or by a combination thereof, the processor 70 may represent an entity (e.g., physically embodied in circuitry) capable of performing operations according to an embodiment of the invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and operations described herein when the instructions are executed. However, in some cases, the processor 70 may be a processor of a specific device (e.g., a mobile terminal or network device) adapted for employing an embodiment of the invention by further configuration of the processor 70 by instructions for performing the algorithms and operations described herein. The processor 70 may include, among other things, a clock, an arithmetic logic unit (ALU) and logic gates configured to support operation of the processor 70.

In an example embodiment, the processor 70 may be configured to operate a connectivity program, such as a browser, Web browser or the like. In this regard, the connectivity program may enable the apparatus 50 to transmit and receive Web content, such as for example location-based content or any other suitable content, according to a Wireless Application Protocol (WAP), for example. The processor 70 may also be in communication with a display 85 and may instruct the display to illustrate any suitable information, data, content (e.g., media content) or the like.

Meanwhile, the communication interface 74 may be any means such as a device or circuitry embodied in either hardware, a computer program product, or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network (e.g., network 30). In fixed environments, the communication interface 74 may alternatively or also support wired communication. As such, the communication interface 74 may include a communication modem and/or other hardware/software for supporting communication via cable, digital subscriber line (DSL), universal serial bus (USB), Ethernet or other mechanisms.

The user interface 67 may be in communication with the processor 70 to receive an indication of a user input at the user interface 67 and/or to provide an audible, visual, mechanical or other output to the user. As such, the user interface 67 may include, for example, a keyboard, a mouse, a joystick, a display, a touch screen, a microphone, a speaker, or other input/output mechanisms. In an example embodiment in which the apparatus is embodied as a server or some other network devices, the user interface 67 may be limited, remotely located, or eliminated. The processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

The apparatus 50 may optionally include a media capturing element, such as camera module 36. The camera module 36 may include a camera, video and/or audio module, in communication with the processor 70 and the display 85. The camera module 36 may be any means for capturing an image, video and/or audio for storage, display or transmission. For example, the camera module 36 may include a digital camera capable of forming a digital image file from a captured image. As such, the camera module 36 may include all hardware, such as a lens or other optical component(s), and software necessary for creating a digital image file from a captured image. Alternatively, the camera module 36 may include only the hardware needed to view an image, while a memory device (e.g., memory device 76) of the apparatus 50 stores instructions for execution by the processor 70 in the form of software necessary to create a digital image file from a captured image. In an example embodiment, the camera module 36 may further include a processing element such as a co-processor which assists the processor 70 in processing image data and an encoder and/or decoder for compressing and/or decompressing image data. The encoder and/or decoder may encode and/or decode according to a Joint Photographic Experts Group, (JPEG) standard format or other like formats for two-dimensional (2D), three-dimensional (3D) video such as the Motion Picture Experts Group (MPEG) formats. In some cases, the camera module 36 may provide live image data to the display 85. In this regard, the camera module 36 may facilitate or provide a camera view to the display 85 to show live image data, still image data, video data, or any other suitable data. Moreover, in an example embodiment, the display 85 may be located on one side of the apparatus 50 and the camera module 36 may include a lens positioned on the opposite side of the apparatus 50 with respect to the display 85 to enable the camera module 36 to capture images on one side of the apparatus 50 and present a view of such images to the user positioned on the other side of the apparatus 50.

In addition, the apparatus 50 may include a positioning sensor 72. The positioning sensor 72 may include, for example, a global positioning system (GPS) sensor/receiver, an assisted global positioning system (Assisted-GPS) sensor, a Bluetooth (BT)-GPS mouse, other GPS or positioning receivers or the like. However, in one example embodiment, the positioning sensor 72 may include a pedometer or inertial sensor. In this regard, the positioning sensor 72 may be capable of determining a location of the apparatus 50, such as, for example, longitudinal and latitudinal directions of the apparatus 50, or a position relative to a reference point such as a destination or start point. The positioning sensor 72 may also be capable of determining an altitude of the apparatus 50 and use the altitude information in determining the location of the apparatus 50. Information from the positioning sensor 72 may then be communicated to a memory of the apparatus 50 or to another memory device to be stored as a position history or location information.

In an example embodiment, the apparatus 50 may further include (or be in communication with) an orientation module 71. The orientation module 71 may be any means such as a device or circuitry embodied in either hardware or a combination of hardware and software that is configured to determine the orientation of apparatus 50 and/or of the field of view of the camera module 36 of the apparatus 50.

The orientation module 71 may be configured to determine the orientation of apparatus 50 relative to a reference. In some cases, the reference may be a particular direction, such as North or another cardinal direction. However, other references may also be employed. As such, in one embodiment, the orientation module 71 may include a compass or other orientation sensor, such as, for example, a gyroscope, configured to determine the heading of the apparatus 50 or direction that the lens of the camera module 36 is pointing. The direction or heading may be determined in terms of degrees (e.g., 0 to 360 degrees) offset from the reference. In some cases, the reference may be fixed (e.g., a fixed directional reference), while in other cases, the reference may be a reference of opportunity such as a prominent feature in an image captured by the camera module or simply an initial orientation.

In an example embodiment, the orientation of the field of view of the camera module 36 may be compared to the reference in order to determine the current orientation of the apparatus 50. Thus, for example, given an initial image, a particular feature may be selected as the reference. Thereafter, as the field of view is altered, the orientation module 71 may be configured to determine the orientation of the field of view of the camera module 36 based on the speed or amount of movement relative to the reference. While one embodiment may only determine orientation in a single plane (e.g., parallel to the surface of the earth), another embodiment may allow for orientation determination including an elevation aspect and/or axial aspect shifts. Thus, for example, the orientation module 71 may be configured to determine pitch and/or yaw of the apparatus 50 (e.g., pitch defining a degree of elevation and yaw defining an axial rotation). As such, for example, the orientation module 71 may include a device or other means for determining the orientation of the apparatus 50 (or the field of view of the camera module 36), which may be referred to as orientation information. In one embodiment, the orientation module 71 may include an electronic/digital compass, a horizon sensor, gravity sensor, accelerometer, gyroscope, magnetometer and/or the like or any other sensor that may be useful in determining orientation information.

In an example embodiment, the processor 70 may be embodied as, include or otherwise control the media content module. The media content module 78 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the media content module 78 as described below. Thus, in an example in which software is employed, a device or circuitry (e.g., the processor 70 in one example) executing the software forms the structure associated with such means.

In one example embodiment, the media content module 78 may retrieve images and/or videos which may include one or more objects defined by location(s) and time (or series of locations and times). The images and/or videos may be captured by the camera module 36 and may be stored in memory device 76 and/or a remote memory (e.g., a memory of a network device (e.g., a server)). In this regard, the media content module 78 may sensor data saved together with the images and/or videos to enable retrieval of images and/or videos from a memory (e.g., memory device 76). The saved sensor data may include, but is not limited to, a measurement(s) of a digital compass (e.g., a direction), a location measurement(s) and a timestamp(s) of these measurements. In an example embodiment, in response to capturing an image(s) and/or video(s), the camera module 36 may timestamp the image(s) and/or video(s) by assigning a time (e.g., date, hours, minutes, etc. (e.g., 7:00 AM on October 12^{th})) to the image(s) and/or video(s). Additionally, the camera module 36 may timestamp the measurements by assigning the time in which the measurements were obtained to the captured image(s) and/or video(s).

The location information associated with an image and/or video may be obtained from a GPS receiver of the positioning sensor 72 and may be saved together with the image(s) and/or video(s) in a memory device. For instance, the GPS receiver of the positioning sensor 72 may determine the coordinates (e.g., latitude and longitude coordinates, altitude coordinates, etc.) of the apparatus 50 capturing objects of an image(s) and/or video(s) and may save this location information with the data of the image(s) and/or video(s). In an example embodiment, the GPS receiver of the positioning sensor 72 may also determine locations of one or more objects captured in the image and/or video. The GPS receiver of the positioning sensor 72 may determine the coordinates of the objects based in part on determining latitude, longitude, and altitude coordinates of the objects.

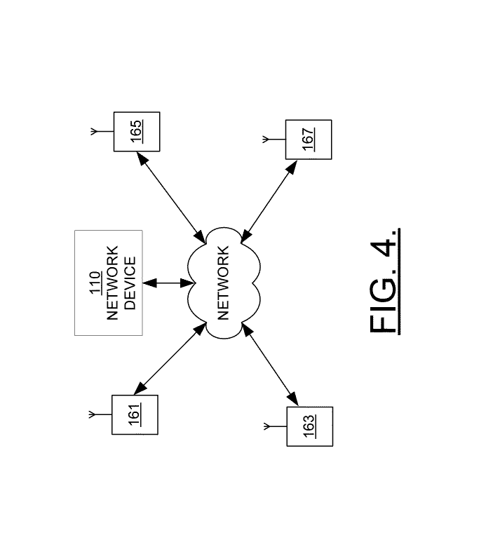

In an example embodiment, the angle of view (e.g., in horizontal and/or in vertical directions) of the camera module 36, detected by the orientation module 71 may be saved together with data of captured images and videos. For instance, the orientation module 71 may determine the angle of view of a captured image(s) and/or video(s) and may provide this information to the camera module 36 to enable the camera module 36 to save, in a memory (e.g., memory device 76), the angle of view data with the data of the captured image(s) and/or video(s). The angle of view information may be transmitted, for example, by the camera module 36, to another communication device(s) (e.g., network device 110, communication devices 161, 163, 165, 167 of FIG. 4) via a network (e.g., network 30) using a communication protocol. In an example embodiment, the communication protocol may conform to the International Organization for Standardization (ISO) Open Systems Interconnection (OSI) protocol stack. However, any other suitable communication protocols may be utilized to transmit the angle of view information to another communication device(s). In some example embodiments, the angle of view information may be received from one or more of the other communication devices. Additionally, the orientation module 71 may provide detected changes in the angle of view (e.g., zooming) of a captured image(s) and/or video(s) and information associated with the changes in the angle of view may be saved by the camera module 36 together with the data of the image(s) and/or video(s). In addition, the information indicating the changes in the angle of view may be transmitted, by the camera module 36, to another communication device(s) (e.g., network device 110, communication devices 161, 163, 165, 167 of FIG. 4). In some example embodiments, information indicating the changes in the angle of view may be received from one or more of the communications devices. The orientation module 71 may also provide the camera module 36 with accelerometer and/or gyroscope measurements detected in an instance in which the camera module 36 captures an image(s) and/or video(s). The accelerometer and/or gyroscope measurements may be used by the camera module to determine the tilt of the camera module 36 with respect to a horizontal plane. The accelerometer and/or gyroscope measurements may be saved, by the media content module, together with the data of the image(s) and/or video(s). The media content module 78 may also provide the accelerometer and/or gyroscope measurements to one or more other communication devices (e.g., network device 110, communication devices 161, 163, 165, 167 of FIG. 4) to enable the communication devices to determine the tilt of a camera module(s) 36. In some example embodiments, the media content module 78 may receive accelerometer and/or gyroscope measurements from one or more of the communication devices.

In an example embodiment, the media content module 78 may retrieve position and time criteria based on historical location and time data of one or more users attending an event(s) (e.g., a public event(s)). Subsequently, one or more video segments captured by the camera module 36 satisfying the position and time criteria may be prioritized for inclusion as part of an automatic real-time or non real-time video remix creation. For purposes of illustration and not of limitation, the position and time criteria may relate to location data indicating an auditorium of a public event such as, for example, a concert at a certain time (e.g., 7:00 PM) or time period in which one or more users (e.g., Users A, B, C) of apparatuses 50 may be attending the concert. In this regard, in an instance in which the media content module 78 determines that the camera module 36 subsequently captures an image(s) and/or video(s) at the location at the time or during the time period, the media content module 78 may prioritize the image(s) and/or video(s) for inclusion as part of an automatic real-time or non real-time video remix creation.

Additionally, the positioning sensor 72 may determine the distance _{[c1]}between the camera module 36 and one or more devices (e.g., apparatuses 50) that the positioning sensor 72 may detect in an image and/or video or devices which may be in view of the camera module 36. In some example embodiments, the distance information may be provided by the positioning sensor 72 to one or more other communication devices (e.g., network device 110, communication devices 161, 163, 165, 167 of FIG. 4). In other example embodiments, the distance between a camera and devices detected in an image/video in the field of view of the camera may be received by the positioning sensor 72 from one or more communication devices (network device 110, communication devices 161, 163, 165, 167 of FIG. 4).

In another example embodiment, the media content module 78 may detect one or more interesting video views based in part on the motion activity of objects (e.g., people, devices (e.g., sensor-enabled devices)) which are located within the field of view of the camera module 36. In this regard, the media content module 78 may detect sensor-enabled devices such as, for example, other apparatuses 50 in which some of these other apparatuses 50 may not have a camera module (e.g., camera module 36). However, the media content module 78 may be capable of detecting the sensor-enabled devices (e.g., other apparatuses 50) which may record sensor data about their motion and their location. The media content module 78 may provide the interesting video views to other communication devices (e.g., network device 110, communications devices 161, 163, 165, 167 of FIG. 4). In addition, in some example embodiments, the media content module 68 may receive interested video views detected by one or more of the communication devices.

The field of view of the camera module 36 capturing objects may be determined from compass measurements and the angle of view of the camera module 36 used for the video recording by the orientation module 71. The motion information relating to detected objects (e.g., individuals or people) within the field of view of the camera module may be determined by analyzing gyroscope sensor data and/or other sensor data obtained or detected by the orientation module 71. In another example embodiment, the motion information relating to detected objects within the field of view of the camera module 36 may be determined by analyzing accelerometer and/or gyroscope sensor data and/or other sensor data obtained or detected by the orientation module 71. In an example embodiment, the field of view information and the motion information may be provided by the camera module 36 to one or more other communication devices (e.g., network device 110, communication devices 161, 163, 165, 167 of FIG. 4). In addition, the camera module 36 may receive field of view information and motion information from one or more communication devices.

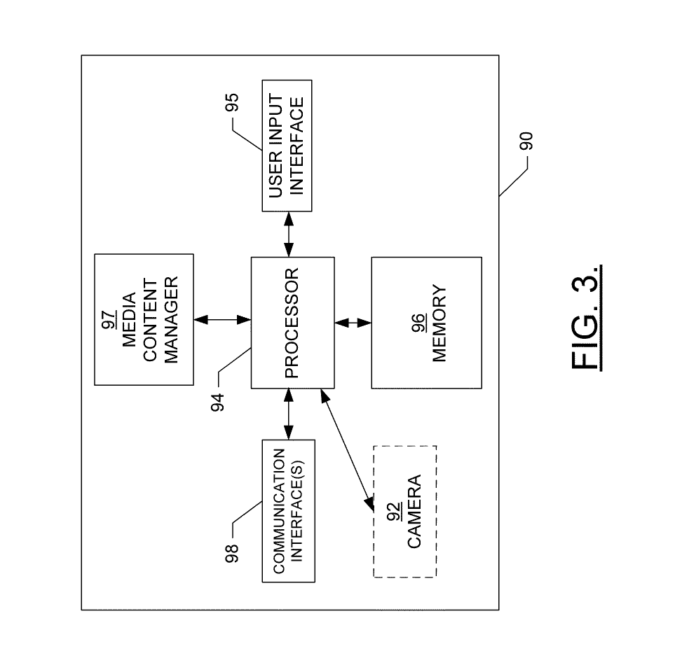

In another example embodiment, the motion information related to detected objects within the field of view of the camera module 36 may be determined by analyzing video content and/or other sensor data captured by the camera module 36. Additionally, the location of detected objects within the field of view of the camera module maybe determined by a GPS receiver of the positioning sensor 72. In another example embodiment, the context data recorded by one or more sensor-enabled devices of users which may not be recording video at an event may be utilized by the media content module 78 to infer the semantics of content (e.g., a video(s) and/or image(s)) recorded by sensor-enabled devices of other users. This semantic information may be used to prioritize inclusion of certain video segments during automatic video remix creation. The semantics information (e.g., a video(s) and/or image(s)) may include or be associated with one or more pre-defined gestures that may be inferred from context data recorded from one or more users present at the event (e.g., a public event). In this regard, users may utilize the media content module 78 to improve real-time or non real-time video remix creation. Additionally, users may utilize the media content module 78 to enhance media retrieval mechanisms even in instances in which an apparatus did not record a corresponding video or capture an image. For instance, images and/or videos captured by the camera module 36 may be provided to a network device (e.g., network device 90 of FIG. 3) and users may obtain the images and/or videos from the network device. In one embodiment the network device may provide the received images and/or videos to requesting devices (e.g., apparatuses 50) in response to verifying that a user of the requesting device is a subscriber to a social media network (e.g., Facebook™, Twitter™, LinkedIn™, etc.)

Referring now to FIG. 3, a block diagram of one example of a network device is provided. As shown in FIG. 3, the network device (e.g., a server (e.g., second communication device 20)) generally includes a processor 94 and an associated memory 96. The memory 96 may comprise volatile and/or non-volatile memory, and may store content, data and/or the like. For example, the memory may store content, data, information, and/or the like transmitted from, and/or received by, the network device. In an example embodiment, the memory 96 may store content motion data and/or motion sensor data including but not limited to: (1) angle of view information; (2) information associated with changes in angles of view; (3) accelerometer and/or gyroscope measurements; (4) distance information denoting distance between a camera and devices detected in an image and/video or devices in the field of view of a camera (e.g., camera module 36); (5) information indicating detected interesting video views; (6) field of view information; (7) motion information; and (8) any other suitable data transmitted from, and/or received by, the network device 90, in the manner described above. Also for example, the memory 96 may store client applications, instructions, and/or the like for the processor 94 to perform the various operations of the network device in accordance with an embodiment of the invention, as described herein. The memory 96 may include data associated with media data (e.g., images, videos, audio data, etc.).

In addition to the memory 96, the processor 94 may also be connected to at least one interface or other means for displaying, transmitting and/or receiving data, content, and/or the like. In this regard, the interface(s) may comprise at least one communication interface 98 or other means for transmitting and/or receiving data, content, and/or the like, as well as at least one user input interface 95. The user input interface 95, in turn, may comprise any of a number of devices allowing the network device to receive data from a user, such as a keypad, a touch display, a joystick or other input device. In this regard, the processor 94 may comprise user interface circuitry configured to control at least some functions of one or more elements of the user input interface. The processor and/or user interface circuitry of the processor may be configured to control one or more functions of one or more elements of the user interface through computer program instructions (e.g., software and/or firmware) stored on a memory accessible to the processor (e.g., volatile memory, non-volatile memory, and/or the like).

In an example embodiment, the processor 94 may be embodied as, include or otherwise control the media content manager 97. The media content manager 97 may be any means such as a device or circuitry operating in accordance with software or otherwise embodied in hardware or a combination of hardware and software (e.g., processor 94 operating under software control, the processor 94 embodied as an ASIC or FPGA specifically configured to perform the operations described herein, or a combination thereof) thereby configuring the device or circuitry to perform the corresponding functions of the media content manager 97, as described herein. Thus, in an example in which software is employed, a device or circuitry (e.g., the processor 94 in one example) executing the software forms the structure associated with such means.

The media content manager 97 may detect content motion and/or motion sensed by motion-sensors embedded in communication devices (e.g., communication devices 161, 163, 165, 167 of FIG. 4) within the field of view of a camera (e.g., an optional camera 92 of network 90 and/or an external camera(s) (e.g., camera module 36)) based in part on analyzing image/video content and motion-sensor data stored in the memory 96, as described more fully below.

Referring now to FIG. 4, a diagram of a system according to an example embodiment is provided. The system 7 may include a network device 110 (e.g., network device 90) and one or more communication devices 161, 163, 165, 167 (also referred to herein as sensor-enabled devices 161, 163, 165, 167) (e.g., apparatuses 50). In the example embodiment of FIG. 4, the communication devices 161 and 165 may have cameras (e.g., camera modules 36) whereas as the communication devices 163, 165 may not necessarily have cameras. Although the system 7 of FIG. 4 includes one network device 110, and four communication devices 161, 163, 165, 167, the system 7 may include any suitable number of network devices 110 and communication devices 161, 163, 165, 167 without departing from the spirit and scope of the invention. In an example embodiment, the network device 110 may receive content motion data and/or motion sensor data (e.g., motion measurements) as well as any other suitable data from the communication devices 161, 163, 165, 167.

In some example embodiments, the content motion data and/or motion sensor data may, but need not, correspond to information of a communication device(s) (e.g., communication device 163) being captured in a field of view of a camera (e.g., camera module 30) of another communication device (e.g., communication device 161). In addition, some communication devices (e.g., communication devices 163, 167) may provide their corresponding content motion data and/or sensor data to the network device 110 even in instances in which the communication devices may not be capturing images and/or videos. The network device 110 may also send content motion data and/or motion sensor data to the communication devices 161, 163, 165, 167 as well as any other suitable data. A media content manager (e.g., media content manager 97) of the network device 110 may analyze the content motion data and/or motion sensor data to retrieve one or more images and/or videos from a memory (e.g., memory 96). For instance, the media content manager 97 may analyze contextual data of the recording activity (e.g., recording video(s), a captured image(s)), including but not limited to the angle of view of a recording camera (e.g., camera module 36), the orientation of a recording camera, sensor data from the objects to be detected (e.g., location data, motion-sensor data, etc.), distance between recording camera and objects, video content motion analysis data, audio content analysis data, etc. As such, the media content manager 97 may utilize this information to accurately retrieve media content (e.g., images, videos, audio data, etc.). Additionally, the media content manager of the network device 110 may analyze the content motion data and/or motion sensor data to detect one or more correlations for determining one or more videos and/or video segments of interest, as described more fully below.

In an example embodiment, the media content module 78 and/or media content manager 97 may determine a correlation between the motion sensed by motion sensors (e.g., an accelerometer and/or gyroscope of the orientation module 71) embedded in the sensor-enabled devices (e.g., other apparatuses 50 (e.g., communication devices 161, 163, 165, 167)) being captured within the field of view of the camera module 36 and the motion of these sensor-enabled devices extracted from the recorded video captured by the camera module 36 to determine the confidence related to the interestingness of the recorded video(s), as described more fully below.

The media content module 78 and/or media content manager 97 may also determine a correlation between the motion of objects sensed by motion sensors embedded in the sensor-enabled devices being captured within the field of view of the camera module 36 and the tempo or pace of audio data (e.g., music content) recorded by the apparatus 50 for an event (e.g., a public event). In this regard, the media content module 78 and/or media content manager 97 may analyze the correlation for determining the confidence relating to the interestingness of a corresponding video recording.

In another example embodiment, the media content module 78 and/or media content manager 97 may determine a correlation between the motion of objects sensed by motion sensors embedded in the sensor-enabled devices being captured within the field of view of the camera module 36 and the detected motion of these sensor-enabled devices extracted from a recorded video and/or a tempo or pace of the audio data (e.g., music content) recorded and associated with the recorded video. The recorded video and associated audio data may be captured during a corresponding event (e.g., a public event) and the correlation data may be analyzed by the media content module 78 for determining the confidence about the interestingness of the recorded video. In an example embodiment, the determined correlation data described above may be provided by the media content module 78 and/or the media content manager to one or more other devices (e.g., another network device 110, communication devices 161, 163, 165, 167) to enable a media content module or media content manager of the devices to determine the confidence related to the interestingness of the recorded video(s).

In one example embodiment, a collection of images and/or videos, together with context data may be stored in any suitable manner such as, for example, in a memory, (e.g., memory device 76, memory 96) a database, a file (e.g., embedded in a media file, etc.) In one example embodiment, all or a portion of the collection of images and/or videos together with the context data described below may be provided by the media content module 78 and/or media contend manager 97 to one or more other communication devices (e.g., other network devices 110, communication devices 161, 163, 165, 167). The context data may include, but is not limited to, the following: (1) location information which may be provided by the positioning sensor 72 as a pair of latitude and longitude coordinates, and/or altitude coordinates) in which the location information may relate to one or more location measurements and a corresponding timestamp(s) in which the location measurements were obtained—accommodating camera modules 36 that may be moving during a recording (e.g., a video recording); and (2) orientation information which may be detected by an electronic compass of the orientation module 71 in which the orientation information may relate to one or more orientation measurements and a corresponding timestamp(s) in which the orientation information was obtained. The orientation information may accommodate panning movements of the camera module 36.

In addition, the context data may, but need not, include the following data: (1) one or more angles of view of the camera module 36 and their corresponding timestamps indicating a time in which the orientation module 71 measured the angles of view—the angles of view of the camera module 36 may be utilized to accommodate for changes in the zoom level of the camera module 36. Also, in an instance in which the vertical and horizontal angles of view are different, then each of them (or a series of them) may be included in the context data; (2) one or more accelerometer and/or gyroscope measurements and timestamps corresponding to the accelerometer and/or gyroscope measurements indicating the time in which the accelerometer and/or gyroscope measurements were obtained by an accelerometer (e.g., a triaxial accelerometer sensor) and/or gyroscope of the orientation module 71. The triaxial accelerometer sensor may measure static acceleration that may be utilized by the camera module 36 for detecting the tilt of the camera module 36 with respect to the horizontal plane.

In one example embodiment, the media content module 78 and/or media content manager 97 may retrieve one or more images and/or videos from a memory (e.g., memory device 76, memory 96) based in part on analyzing location data assigned to the images and/or videos, location data assigned to other objects (e.g., other cameras or any other device(s) for which location information is available) and the time the image(s) and/or video(s) was captured as well as a desired maximum angle (Amax) deviation from a central orientation (e.g., specifying that the line connecting the recording camera (e.g., camera module 36) to an object(s) of the image(s) and/or video(s) should be within some predefined angle from an optical axis of the camera module 36, over-riding the angle of view of an individual video(s) and/or image(s)). This information may be provided by the media content module 78 and/or media content manager 97 to other devices (e.g., other network devices 110, communication devices 161, 163, 165, 167) to enable the other devices to utilize this information retrieve stored images/videos and/or determine the interestingness of one or more videos or for any other suitable usages. The location data assigned to the images and/or videos may be the location of the camera module capturing the images/videos or one or more objects captured in the images and/or videos. The angular difference between the line connecting the recording camera (e.g., camera module 36) to an object(s) of the image(s) and/or video(s) and the central orientation of the recording camera should be equal or smaller than half the angle of view of the recording camera, in order to detect the object(s) as being within the field of view of the recording camera.

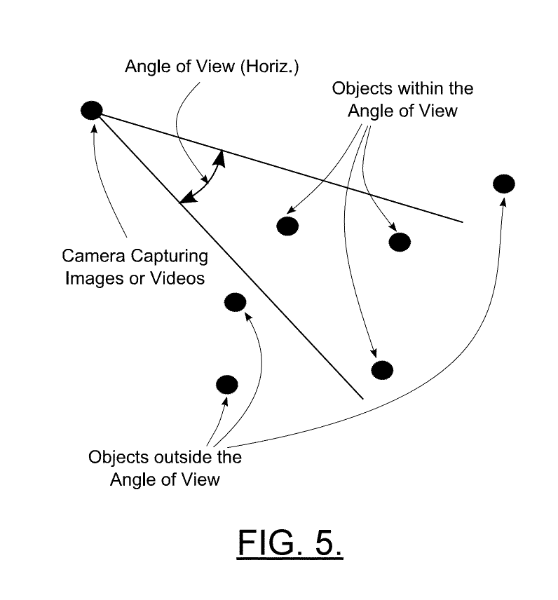

Referring now to FIG. 5, a diagram illustrating one or more objects that are within the field of view of a camera module is provided. In the example embodiment of FIG. 5, a camera (e.g., camera module 36) of an apparatus (e.g., apparatus 50) may detect one or more objects within an angle/field of view of the camera while capturing one or more images and/or videos. Additionally, FIG. 5 illustrates one or more objects outside of the angle of view of the camera. The objects outside of the angle of view of the camera may not be detected or captured by the camera.

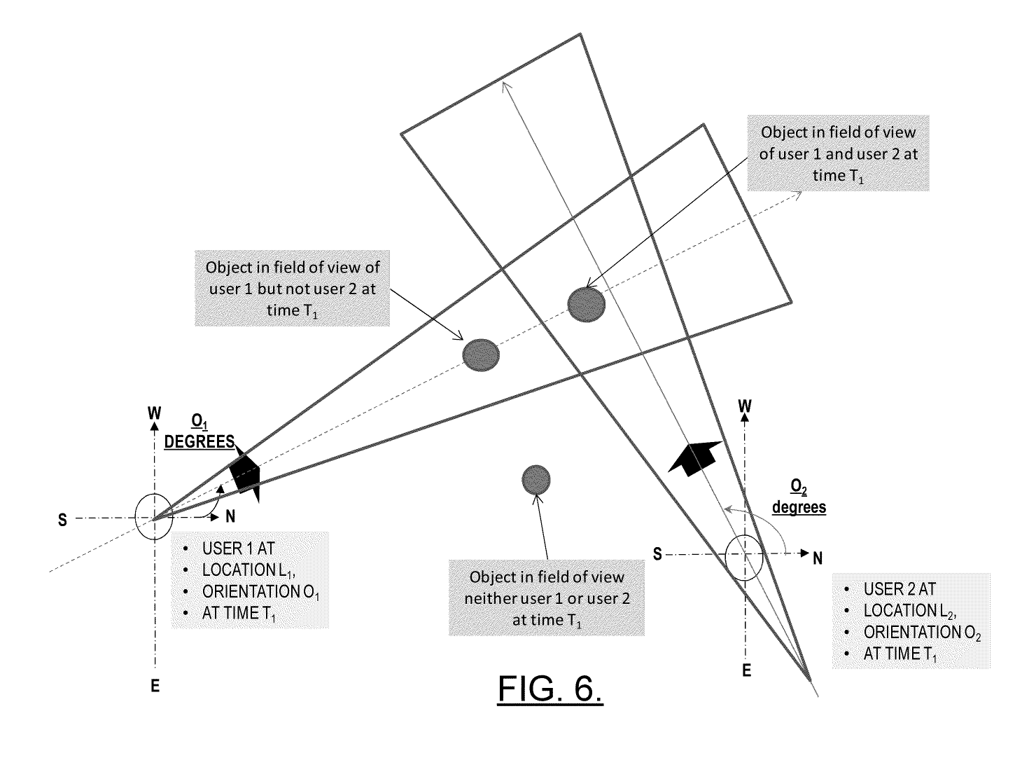

In the example embodiments of FIGS. 5 and 6, a flat spatial model indicating the input location of a camera (e.g., camera module 36) capturing objects or the location(s) of one or more objects within the angle of view of the camera being captured may characterized by a pair of coordinates (e.g., x and y coordinates). In this regard, presume that magnetic North coincides with the direction of the X-axis of a coordinate system and magnetic West coincides with the Y-axis of the coordinate system. The location of objects (e.g., cameras and any other devices and/or persons for which location information is available) may be characterized by the coordinates (Xs,Ys).

Referring now to FIG. 6, a diagram illustrating camera modules of apparatuses and objects associated with coordinates according to an example embodiment is provided. In the example embodiment of FIG. 6, a location L₁ of a user 1 may be detected by a positioning sensor (e.g., positioning sensor 72) and an orientation 0₁ of a camera module (e.g., camera module 36) may be detected by an orientation module (e.g., orientation module 71) at time T₁. Additionally, a location L₂ of a user 2 may be detected by a positioning sensor and an orientation 0₂ of another camera module (e.g., camera module 36) may be detected by an orientation module at time T₁. In this regard, the camera module of user 1 may capture an object in field of view of user 1 but not user 2 at time T₁. Moreover, an object may not be in the field of view of either user 1 or user 2 at time T₁. Additionally, the camera module of user 1 and the camera module of user 2 may detect an object in the field of view of user 1 and user 2 at time T₁.

The search (also referred to herein as retrieval), by the media content module 78 and/or media content manager 97, for one or more videos, for example in an available collection of videos (e.g., in which one or more desired objects may be recorded) may be performed in the following manner. First, for each video indexed by i, the media content module 78 and/or media content manager 97 may establish a line that connects coordinates (Xi,Yi) of the video with (Xs,Ys) and then computes the anti-clockwise angle between the line and the X-axis. This may be computed by the media content module 78 and/or media content manager 97 as Ai=arctan((Ys-Yi)/(Xs-Xi)). In response to computing Ai, the criteria for matching video i may utilize the following: (1) orientation criterion in which the angle difference between Ai and the camera module recording orientation Oi (e.g., context information) should not exceed Amax degrees; (2) time criterion in which the time difference of a recording and the input time should be within a time interval defined as Tmax (e.g., which may also be input or provided to the media content module 78 (and/or media content manager 97) or a default value may be used); and (3) distance criterion in which the distance between the camera module recording and a requested object should be smaller than a Dmax (e.g., which may also be input or provided to the media content module 78 (and/or media content manager 97) or a default value may be used). Any suitable method for computing the distance between two spatial points for which location information is available may be used. In an instance in which location information is available in terms of Cartesian coordinates, Euclidean distance may be computed. In an instance in which location information is available in terms of latitude and longitude coordinate pairs (e.g., as the data given by a GPS receiver), the distance may be estimated by considering the surface of earth as either flat, spherical or ellipsoidal.

In an instance in which the horizontal angle of view Hi of the camera module is saved as context information for a certain video in the collection, it may be used by the camera module 36 to define Amax, so that Amax=Hi/2. In this regard, the maximum allowed deviation in orientation may be half of the angle of view of the video.

In an instance in which static acceleration information detected by an accelerometer of the positioning sensor 72 is saved as context information for a certain video in the collection by a camera module 36, it may be used to define the tilt angle with respect to the horizontal plane of the camera module 36. Additionally or alternatively, the tilt angle may be determined by analyzing data captured by a gyroscope. In this regard, an additional requirement may be imposed on the tilt angle to be within Lmax degrees from the horizontal plane. In an instance in which the additional requirement is imposed/enabled, Lmax may also be input or provided to the media content module 78 and/or media content manager 97 or a default value may be used. In an example embodiment, the information associated with Tmax, Dmax, Hi, Amax, Lmax and any other suitable information may be provided by the media content module 78 and/or media content manager 97 to other devices to enable the other devices to search (e.g., retrieve) one or more videos.

The distance between the camera module 36 and each requested object(s) (for which location information is available) may be estimated by the media content module 78 and/or media content manager 97 by computing the distance between the respective spatial locations of the camera module 36 and the requested object(s), which may be expressed in terms of coordinates (e.g., latitude, longitude and altitude coordinates).

In another example embodiment, the media content module 78 and/or media content manager may analyze one or more video segments and corresponding saved context data (e.g., motion information captured by motion-sensors embedded in the objects which are within the field of view of the recording camera) in order to determine whether an interesting view is being recorded. In particular, the video content motion activity and the sensor motion information may be jointly analyzed for detecting possible correlations which determine the video segment to be interesting. This may be achieved by the media content module 78 evaluating the motion activity of sensor-enabled devices (which may not necessarily have a camera (e.g. camera module 36)) that are within the field of view of a corresponding video(s) being considered video(s). Alternatively, the joint analysis of content motion and motion sensed by motion-sensors embedded in the devices (e.g., communication devices 161, 163, 165, 167) within the field of view of a camera (e.g., camera module 36) may be performed by any device (e.g., camera module 36 and/or media content module 78 as described above)) which has access to both the video content (or the previously extracted content motion information) and the motion-sensor data, one or all of the objects/devices (e.g., communication devices 161, 163, 165, 167) which may be within the field of view of the camera, or a network device (e.g., network device 110 (e.g., a network server)). In addition to the sensor data described above with respect to the saved context data, the media content module 78 and/or media content manager 97 may consider the angular motion of one or more sensor-enabled devices within the field of view of a camera module. The media content module 78 and/or media content manager 97 may determine the angular motion by receiving one or more measurements from a gyroscope (e.g., a triaxial gyroscope) of an orientation module 71 and corresponding timestamps of the measurements. The angular motion may accommodate for rotational movements of the camera module 36 during a recording. In an example embodiment, the angular motion information may be provided by the media content module 78 and/or media content manager 97 to one or more devices (e.g., other network devices 110, communication devices 161, 163, 165, 167) to enable the devices determine rotation movements of a camera module 36 during a recording in order to determine whether a video(s) is interesting, as described more fully below.

The first step in determining whether a video is an interesting video may, but need not, involve the media content module 78 and/or media content manager 97 identifying the sensor-enabled objects/devices that may be within the field of view of the analyzed video being captured by the camera module 36. This may be accomplished by the media content module 78 and/or media content manager 97 in response to determining whether an object(s) is within a field of view of a camera module. In an example embodiment, an object(s) may be within the field of view in an instance in which: (1) orientation criterion indicates that the angle between the optical axis of the camera module 36 and the line that connects the object(s) and the camera module does not exceed half of the angle of view of the camera module; and (2) distance criterion indicates that the distance between the camera module and the object is within a predefined distance.

In response to one or more objects such as, for example, sensor-enabled devices being identified, by the media content module 78 and media content manager 97, as being located within the field of view of a camera module 36, the recorded context sensor data of the sensor-enabled devices may be analyzed by the media content module 78 and/or media content manager 97 to determine the interestingness of one or more segments in a recorded video(s). In an example embodiment, any movement or gesture that may be determined for one or more users using the sensors available on the sensor-enabled devices carried by the users may be of interest. The media content module 78 and/or media content manager 97 may detect rhythmical movements (e.g., dancing, clapping, jumping with music), of users utilizing sensor-enabled devices, as indicators of an interesting view. The media content module 78 and/or the media content manager 97 may provide information indicating the rhythmical movements to one more devices to enable the other devices to determine the interestingness of a corresponding video(s).

To identify these rhythmical movements, the media content module 78 and/or media content manager 97 may analyze a series of sensor (e.g., accelerometer, gyroscope) measurements corresponding to an individual object(s) in the following manner. First, the media content module 78 and/or media content manger 97 may detect sensor measurement data that may be recorded periodically with a specific sampling rate. Thereafter, the media content module 78 and/or media content manager 97 may evaluate in successive temporal segments the amplitude frequency response of the sensor data that are included in the segments (e.g., video segments). In an instance in which the media content module 78 and/or media content manager 97 detects a maximum amplitude response and determines that the maximum amplitude response falls within a predefined frequency range (e.g., [F1, F2]), then the media content module 78 and/or media content manager 97 may consider an object(s) (e.g., a person(s)) as performing a movement that is interesting. In an example embodiment, values of F2 may, but need not, be smaller than 5 Hz, whereas greater values may be considered as contributed from noise or from inadvertent movements. The media content module 78 and/or media content manager 97 may perform the same analysis for all objects that are captured within the field of view of a camera module 36 and then for each temporal segment of a video recording(s) for which there is at least one such result (e.g., maximum amplitude response falls within a predefined frequency range) detected by the media content module 78 and/or media content module 97, the media content module 78 and/or the media content manager 97 may consider all the estimated results (e.g., the detected interesting objects) as the final indication of whether a specific video segment is interesting or not. For example, if at specific time, there are five objects captured within the field of view of the camera module 36 and media content module 78 and/or media content manager 97 detected interesting movements in three of the objects, then the media content module 78 may consider that the recorded view detected at this time is interesting. In an alternative example embodiment, instead of considering all the estimated results (e.g., the detected interesting objects) as the final indication of whether a specific video segment is interesting, a different criterion may be utilized by the media content module 78 and/or media content manager 97. For example, in an instance in which the media content module 78 and/or media content manager 97 determines that there is at least one object in a field of view of the camera module 36 performing an interesting movement, the media content module 78 and/or media content manager 97 may determine that the view of a corresponding video(s) is interesting.

The media content module 78 and/or media content manager 97 may also jointly analyze different data modalities in order to determine whether a view is interesting. In this regard, the media content module 78 may determine a confidence relating to the interestingness of a recorded video(s), as described more fully below.

In some instances, sensor-enabled devices (e.g., devices equipped with motion or other sensors like altitude, etc.) may be inside the field of view of the camera module 36, and the sensor-enabled devices (e.g., communication devices 161, 163, 165, 167) may be moving (for e.g., in instances in which people carrying the devices dance or jump). Although the sensor-enabled devices may be in the field of view of the camera module 36, for any number of reasons, the camera module 36 may not necessarily record a video including the sensor-enabled devices (e.g., in instances in which there are obtrusive people and/or objects between the sensor-enabled devices and the camera module 36) or the sensor-enabled devices may be too small compared to the overall video or image resolution, for being perceived as interesting. In order to take this into account, the media content module 78 and/or media content manager 97 may jointly analyze the content motion of the recorded video and motion sensor data captured or obtained by the sensor-enabled devices inside the field of view of the camera module 36. In this regard, the media content module 78 and/or media content manager 97 may analyze the correlation among the content motion of the recorded video and the motion sensor data to determine an interesting view. For example, in an instance in which the media content module 78 and/or media content manager 97 determines that motion sensor data indicates that the people in the field of view of the camera module are performing some interesting movement (e.g., dancing or jumping, etc.) the media content module 78 and/or media content manager 97 may determine the motion captured by the camera module 36 in different regions of a corresponding video (e.g., by performing a block-based analysis).

As an example, the media content module 78 and/or media content manager 97 may analyze one or more motion vectors and/or an optical flow corresponding to the video to determine the motion captured by the camera module 36 in different regions of the video. In an instance in which the media content module 78 and/or media content manager 97 determines that the correlation between the motion sensed by motion sensors of sensor-enabled devices and the motion estimated from the different regions of the video is high the media content module 78 and/or media content manager 97 may determine that the video being captured by the camera module 36 is capturing the movement/motion of the sensor-enabled devices inside the field of view of the camera module 36. As such, since the media content module 78 and/or media content manager 97 may determine that correlation is high, the media content module and/or media content manager 97 may determine that the view being captured with respect to the corresponding video is an interesting view. In an example embodiment, the media content module 78 and/or media content manager 97 may determine that the correlation between the motion sensed by motion sensors of the sensor-enabled devices and the motion estimated from the different regions of the video is high in an instance in which the correlation exceeds a predetermined threshold.

On the other hand, in an instance in which the media content module 78 and/or media content manager 97 may determine that the correlation between the motion detected from the sensor-enabled devices and the different regions of the video (e.g., a video frame(s)) is small the media content module 78 and/or media content manager 97 may determine that the corresponding video view being considered is not interesting. In an example embodiment, the media content module 78 and/or media content manager 97 may determine that the correlation between the motion sensed by motion sensors of the sensor-enabled devices and the motion estimated from the different regions of the video is small in an instance in which the correlation is below a predetermined threshold.

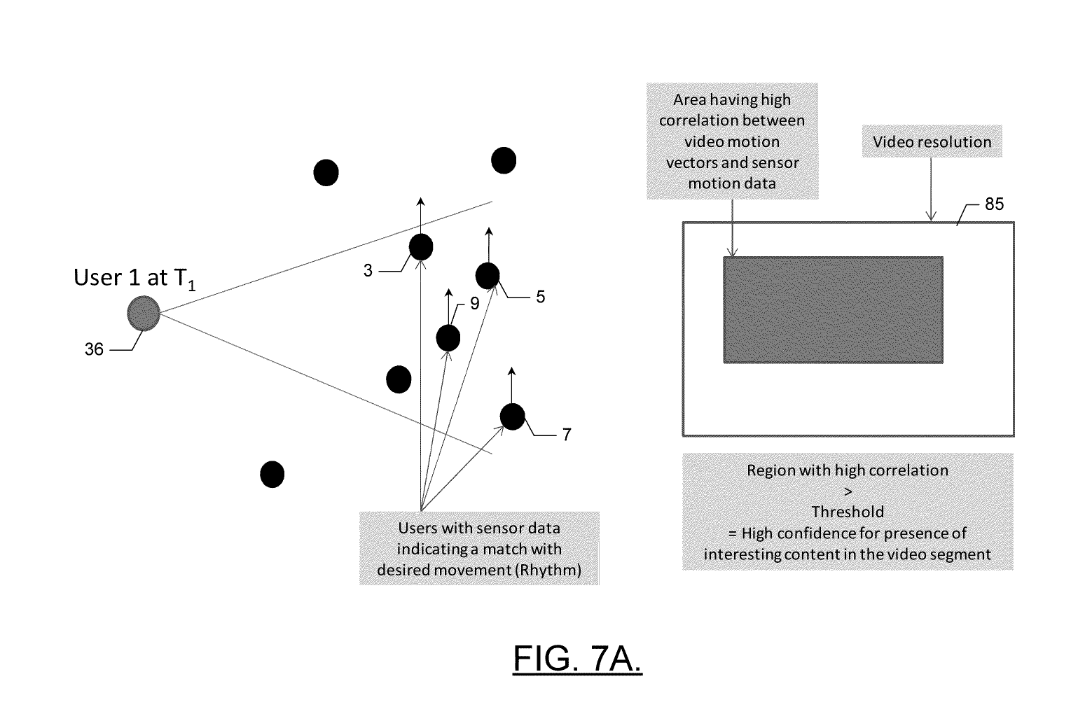

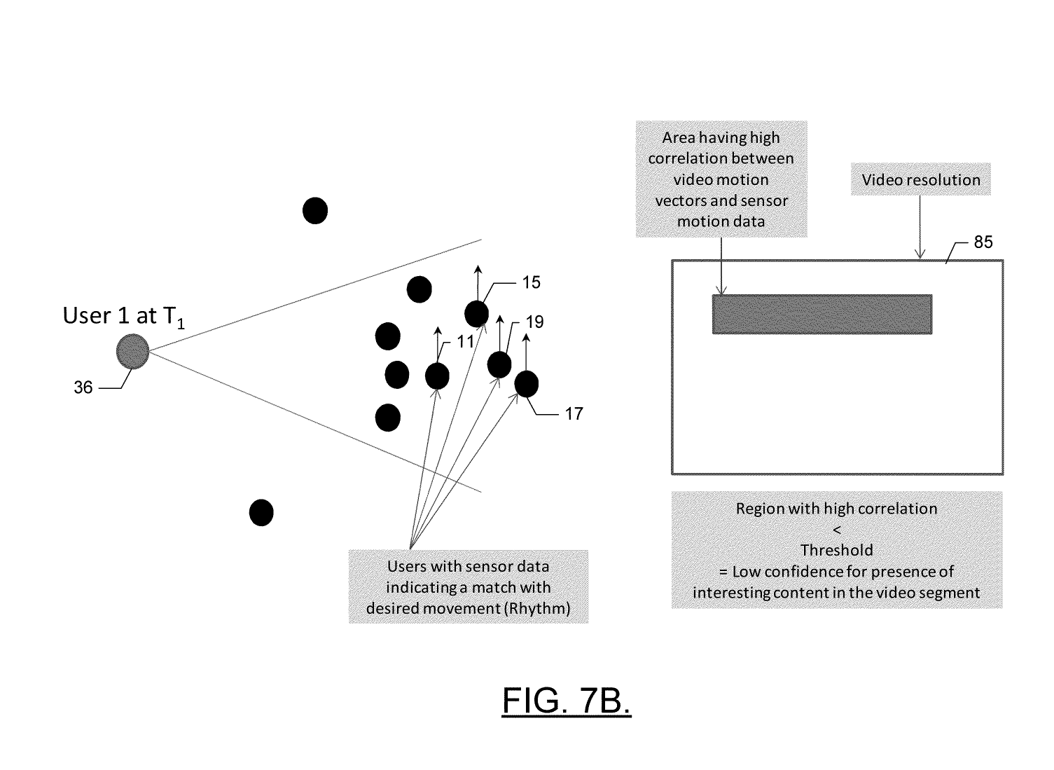

Referring now to FIG. 7A, a diagram illustrating the presence of objects with sensor data in the field of view of a camera according to an example embodiment is provided. In the example embodiment of FIG. 7A, a camera module 36 of a user 1 may detect the presence of devices or objects indicating desired movement in the field of view of the camera module 36. The orientation module 71 in communication with the camera module 36 may detect one or more sensor-enabled devices 3, 5, 7, 9 (e.g., other apparatuses 50 (e.g., communication devices 161, 163, 165, 167)) in the field of view of the camera module 36. The sensor-enabled devices 3, 5, 7, 9 may include one or more motion sensors (e.g., a gyroscope and/or an accelerometer of an orientation module (e.g., orientation module 71), etc.) capable of detecting motion or movement of the sensor-enabled devices 3, 5, 7, 9. In some example embodiments, the sensor-enabled devices 3, 5, 7, 9 may not have a camera (e.g., camera module 36). In some alternative example embodiments, each of the sensor-enabled devices 3, 5, 7, 9 or one or more of the sensor-enabled devices 3, 5, 7, 9 may include a camera (e.g., camera module 36). In the example embodiment of FIG. 7A, the media content module 78 and/or media content module 97 may communicate with the sensor-enabled devices 3, 5, 7, 9 and the sensor-enabled devices 3, 5, 7, 9 may provide their motion sensor data (e.g., motion measurements) to the media content module 78 and/or media content module 97. The video content motion activity and the sensor motion information may be jointly analyzed for detecting possible correlations which determine the video segment(s) to be interesting. The joint analysis of content motion and motion sensed by motion-sensors embedded in the devices (e.g., sensor-enabled devices 3, 5, 7, 9) within the field of view of a camera (e.g., camera module 36) may be performed by any device which has access to both the video content (or previously extracted content motion information) and the motion-sensor data, such as the media content module 78 and/or the media content manager 87, as described above, one or all of the objects/devices which are within the field of view of a camera, or a network device (e.g., another network device 110 (e.g., a network server)). In this regard, the media content module 78 and/or the media content manager 97 may analyze the received motion sensor data and may determine that the motion sensor data indicates movement of users, and/or the sensor enabled devices 3, 5, 7, 9, matching a desired movement (e.g., rhythm). In this manner, the received motion sensor data may be received from local computations of a device (e.g., apparatus 50) or from other devices (e.g., network device 110) via a network. As such, the determination may be performed: (1) locally by a device such as, for example, apparatus 50 (e.g., based on its detected sensor data or based on the sensor data received from other devices) and/or (2) by a network device (e.g., network device 110).

Additionally, a camera module 36 may currently capture a video recording including the sensor-enabled devices 3, 5, 7, 9 and other associated objects (e.g., users carrying the sensor-enabled devices) in the field of view of the camera module 36. In this regard, the media content module 78 and/or media content manager 97 may communicate with a camera module 36 and may determine that the recorded video includes motion/movement of the sensor-enabled devices 3, 5, 7, 9 and/or objects (e.g., users) in the field of view of a camera module 36. In this regard the motion content module may communicate with a local camera module 36 of a device (e.g., apparatus 50) to enable the motion content module 78 to determine the motion/movement of sensor-enabled devices 3, 5, 7, 9 and/or objects in the field of view of the camera module 36. In addition, in this example embodiment, a network device (e.g., network device 110) may communicate with one or more external camera modules (e.g., camera modules 36) of devices (e.g., communication devices 161, 165) to receive data (e.g., recorded video) that enables (e.g., by analyzing the recorded video) a motion content manager of the network device to determine the motion/movement of the sensor-enabled devices 3, 5, 7, 9 and/or objects in the field of view of the one or more camera modules.

In the example embodiment of FIG. 7A, the media content module 78 and/or the media content manager 97 may determine that a correlation between the motion sensed (e.g., sensor motion data) by motion sensors of sensor-enabled devices 3, 5, 7, 9 and the motion estimated (e.g., based in part on video motion vectors) from the different regions of the video recording is high (also referred to herein as a high correlation). In this regard, the media content module 78 and/or the media content manager 97 may determine that the correlation is high in an instance in which a value associated with the determined correlation exceeds a predetermined threshold. As such, the media content module 78 and/or media content manager 97 may determine that there is a high confidence that the presence of interesting content is included in one or more segments of the video recording.

Referring now to FIG. 7B, a diagram illustrating the presence of objects with sensor data in the field of view of a camera according to another example embodiment is provided. In the example embodiment of FIG. 7B, a camera module 36 of a user 1 may detect the presence of devices or objects indicating desired movement in the field of view of the camera module 36. For instance, the camera module 36, via communications with the orientation module 71, may detect one or more sensor-enabled devices 11, 15, 17, 19 (e.g., other apparatuses 50 (e.g., communication devices 161, 163, 165, 167)) in the field of view of the camera module 36. The sensor-enabled devices 11, 15, 17, 19 may include one or more motion sensors (e.g., a gyroscope and/or an accelerometer of an orientation module (e.g., orientation module 71), etc.) capable of detecting motion or movement of the sensor-enabled devices 11, 15, 17, 19. In some example embodiments, the sensor-enabled devices 11, 15, 17, 19 may not have a camera (e.g., camera module 36). In some alternative example embodiments, each of the sensor-enabled devices 11, 15, 17, 19 or one or more of the sensor-enabled devices 11, 15, 17, 19 may include a camera (e.g., camera module 36). The media content module 78 and/or media content manager 97 may communicate with the sensor-enabled devices 11, 15, 17, 19 and the sensor-enabled devices 11, 15, 17, 19 may provide their motion sensor data (e.g., motion measurements) to the media content module 78 and/or media content manager 97.

In this regard, the media content module 78 and/or the media content manager 97 may analyze the received motion sensor data and may determine that the motion sensor data indicates movement of users and the sensor-enabled devices 11, 15, 17, 19 matching a desired movement (e.g., rhythm). In addition, the camera module 36 may currently capture a video recording including the sensor-enabled devices 11, 15, 17, 19 and other associated objects (e.g., users carrying the sensor-enabled devices) in the field of view of the camera module 36. In this manner, the media content module 78 may communicate with the camera module 36 and may determine that the recorded video includes motion/movement of the sensor-enabled devices 11, 15, 17, 19 and/or objects (e.g., users) in the field of view of the camera module 36. As such, the media content module 78 of an apparatus 50 may analyze locally stored (e.g., in a memory device 76) motion sensor data received from sensor-enabled devices 11, 15, 17, 19 and/or video recording data and may determine the motion sensor data and/or the video recording data indicates movement of users and the sensor-enabled devices 11, 15, 17, 19 matching a desired movement. In this example embodiment, the motion content manager 97 may also receive analyze locally stored (e.g., in memory 96) motion sensor data received from sensor-enabled devices 11, 15, 17, 19 and/or video recording data captured from one or more camera modules (e.g., camera modules 36) of devices. In this regard, the motion content manager 97 may determine that the motion sensor data and/or video recording data indicates movement of users and/or sensor-enabled devices 11, 15, 17, 19 matching a desired movement (e.g., rhythm).

In the example embodiment of FIG. 7B, the media content module 78 and/or media content manager 97 may determine that a correlation between the motion sensed (e.g., sensor motion data) by motion sensors of sensor-enabled devices 11, 15, 17, 19 and the motion estimated (e.g., based in part on video motion vectors) from the different regions/segments of the video recording is low (also referred to herein as a low correlation). In this manner, the media content module 78 and/or media content manager 97 may determine that the correlation is low in an instance in which a value associated with the determined correlation is below a predetermined threshold. As such, the media content module 78 and/or media content manager 97 may determine that there is a low confidence that the presence of interesting content is included in one or more segments of the video recording.

In another example embodiment, the media content module 78 and/or media content manager 97 may consider motion sensor data and audio-content data to determine whether a view of a video recording is interesting. A big part of public happenings/events may be based on music such as, for example, live music performances, dance festivals, parties, concerts, etc. In this regard, people attending such events may move/dance in synchrony with the music, for example by following the tempo of the music. As such, in this example embodiment, the media content module 78 and/or media content module 97 may exploit or utilize the correlation between a detected motion of the people captured in a field of view of a camera module 36 during a recording, by the camera module 36, and the detected tempo of the music corresponding to the recording in order to determine with more confidence that a video view of the recording including such people is interesting.

In particular, the media content module 78 and/or media content manager 97 may analyze motion sensor data captured by the sensor-enabled devices being held or carried by people attending the event (e.g., public event (e.g., a musical performance)) in order to determine the pace or rhythm of movement of the people and/or the devices. At or near the same time, the media content module 78 and/or media content manager 97 may analyze the associated audio content to estimate/determine the tempo information (e.g., in the audio segments of corresponding music content). Subsequently, the media content module 78 and/or media content manager 97 may analyze the correlation between the motion of the people's pace and the determined tempo. In an instance in which the media content module 78 and/or media content manager 97 determines that the correlation between the motion of the people's pace and the determined tempo is high (e.g., a high correlation), the media content module 78 and/or media content manager 97 may determine that a corresponding video view recording of the people who are moving in synch with the music is interesting. On the other hand, in an instance in which the media content module 78 and/or media content manager 97 determines that the correlation between the motion of the people's pace and the determined tempo is low (e.g., a low correlation), the media content module 78 and/or media content manager 97 may determine that the corresponding video view recording of the people is not interesting.

In addition, the media content module 78 and/or media content manager 97 may analyze video content (e.g., one or more motion vectors of a video segment(s)) of a corresponding video recording capturing people moving to a tempo (e.g., rhythm) corresponding to associated audio data (e.g., music). In this regard, the video content analysis may be integrated in order to make the analysis more robust. For instance, in an instance in which content-motion extracted from a particular segment/region of view of the analyzed video content is correlated to the tempo (e.g., in terms of pace/rhythm), the media content module 78 and/or media content module 97 may determine that the confidence relating to the interestingness of the view may be increased.

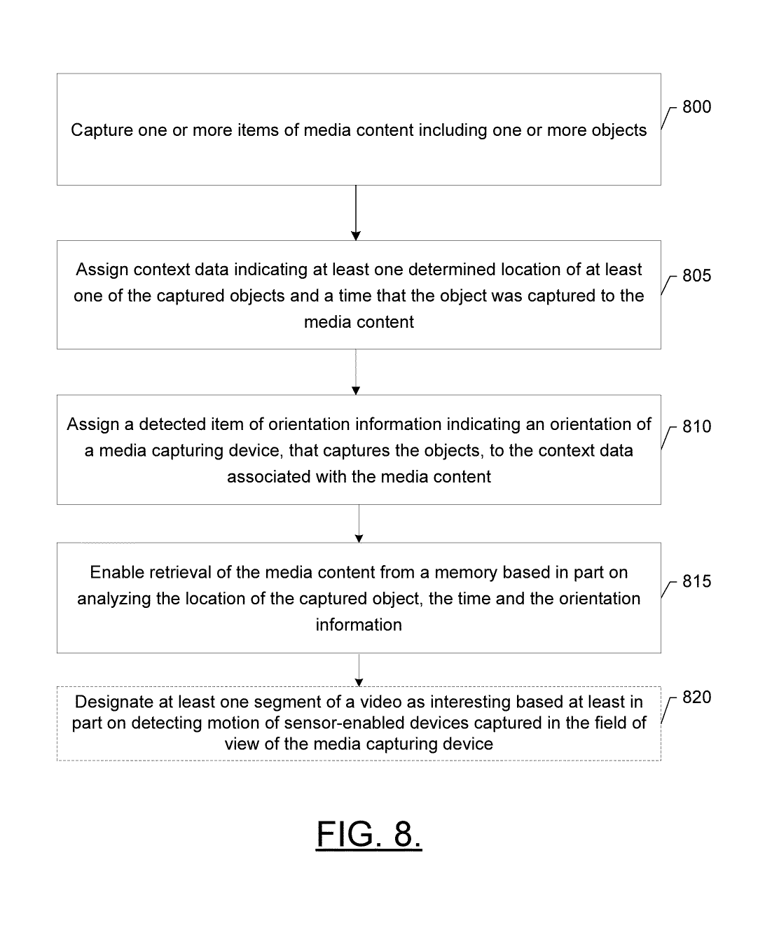

Referring now to FIG. 8, an example embodiment of a flowchart for enabling retrieval of media content and determining whether a portion of the media content is interesting is provided. At operation 800, an apparatus (e.g., apparatus 50) may capture one or more items of media content (e.g., an image(s), a video(s)) including one or more objects (e.g., persons). At operation 805, an apparatus (e.g., apparatus 50) may assign context data indicating at least one determined location (e.g., a latitude coordinate(s), a longitude coordinate(s)) of at least one of the captured objects and a time that the object was captured to the media content.

At operation 810, an apparatus (e.g., apparatus 50) may assign a detected item of orientation information indicating an orientation of a media capturing device (e.g., camera module 36), that captures the objects, to the context data associated with the media content. At operation 815, an apparatus (e.g., apparatus 50) may enable retrieval of the media content from a memory (e.g., memory device 76) based in part on analyzing the location of the captured object, the time and the orientation information (e.g., an indication of a horizontal orientation or a vertical orientation). Optionally, at operation 820, an apparatus (e.g., apparatus 50) may designate at least one segment of a video(s) as interesting based at least in part on detecting motion of one or more sensor-enabled devices (e.g., sensor-enabled devices 3, 5, 7, 9) captured in the field of view of the media capturing device.

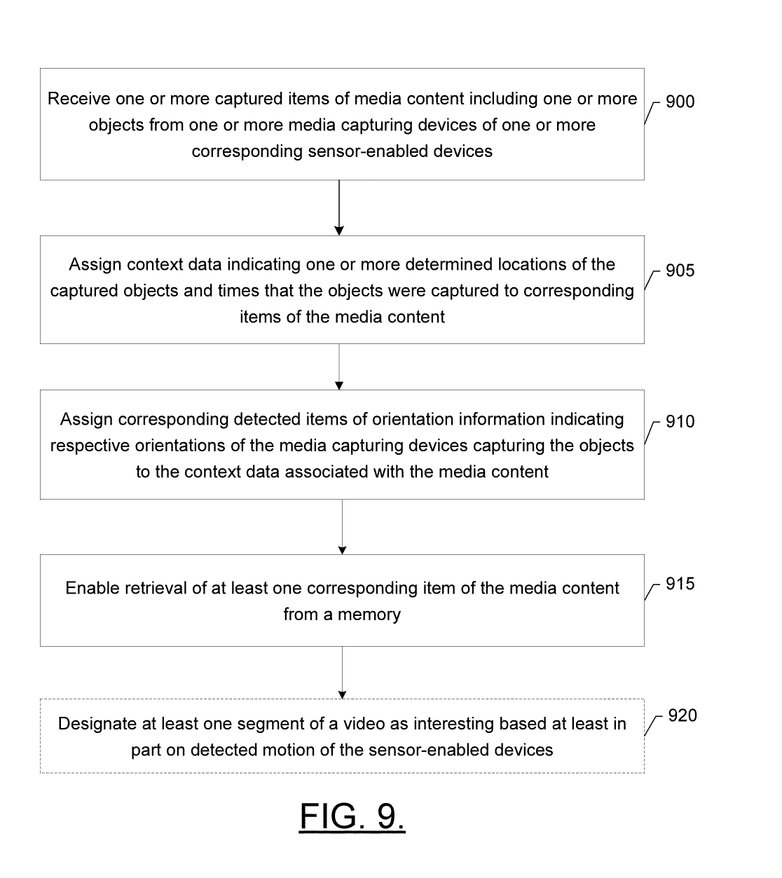

Referring now to FIG. 9, an example embodiment of a flowchart for enabling retrieval of media content and determining whether a portion of the media content is interesting is provided. At operation 900, an apparatus (e.g., network device 110) may receive one or more captured items of media content including one or more objects from one or more media capturing devices (e.g., camera modules 36) of one or more corresponding sensor-enabled devices (e.g., communication devices 161, 165). At operation 905, an apparatus (e.g., network device 110) may assign context data indicating one or more determined locations of the captured objects and times that the objects were captured to corresponding items of the media content (e.g., images, videos, audio data, etc.). At operation 910, an apparatus (e.g., network device 110) may assign corresponding detected items of orientation information indicating respective orientations of the media capturing devices capturing the objects to the context data associated with the media content. At operation 915, an apparatus (e.g., network device 110) may enable retrieval of at least one corresponding item of the media content from a memory. The retrieval may be based in part on analyzing a corresponding determined location of at least one of the captured objects, a corresponding time the object was captured and corresponding orientation information denoting an orientation in which a respective media capturing device captured the object. Optionally, at operation 920, an apparatus (e.g., network device 110) may designate at least one segment of a video as interesting based at least in part on detected motion of the sensor-enabled devices.

It should be pointed out that FIGS. 8 and 9 are flowcharts of a system, method and computer program product according to an example embodiment of the invention. It will be understood that each block of the flowcharts, and combinations of blocks in the flowcharts, can be implemented by various means, such as hardware, firmware, and/or a computer program product including one or more computer program instructions. For example, one or more of the procedures described above may be embodied by computer program instructions. In this regard, in an example embodiment, the computer program instructions which embody the procedures described above are stored by a memory device (e.g., memory device 76, memory 96) and executed by a processor (e.g., processor 70, processor 94, media content module 78, media content manager 97, a co-processor of camera module 36). As will be appreciated, any such computer program instructions may be loaded onto a computer or other programmable apparatus (e.g., hardware) to produce a machine, such that the instructions which execute on the computer or other programmable apparatus cause the functions specified in the flowcharts blocks to be implemented. In one embodiment, the computer program instructions are stored in a computer-readable memory that can direct a computer or other programmable apparatus to function in a particular manner, such that the instructions stored in the computer-readable memory produce an article of manufacture including instructions which implement the function(s) specified in the flowcharts blocks. The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowcharts blocks.

Accordingly, blocks of the flowcharts support combinations of means for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In an example embodiment, an apparatus for performing the method of FIGS. 8 and 9 above may comprise a processor (e.g., the processor 70, processor 94, the media content module 78, the media content manager 97, the co-processor of camera module 36) configured to perform some or each of the operations (800-820, 900-920) described above. The processor may, for example, be configured to perform the operations (800-820, 900-920) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (800-820, 900-920) may comprise, for example, the processor 70 (e.g., as means for performing any of the operations described above), the processor 94, the media content module 78, the media content manager 97, the co-processor of the camera module 36 and/or a device or circuitry for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
capturing one or more items of media content comprising one or more objects;
assigning context data indicating at least one determined location of at least one of the captured objects and a time that the object was captured to the media content;
assigning a detected item of orientation information indicating an orientation of a media capturing device capturing the objects to the context data associated with the media content; and
enabling, via a processor, retrieval of the media content from a memory based in part on analyzing the location of the captured object, the time and the orientation information.

2. The method of claim 1, wherein the media content comprises one or more images or one or more videos captured during an event and wherein the method further comprises:
detecting an angle of view in which the media capturing device captures the object;
assigning data, indicating the angle of view, to the context data associated with the media content,
wherein enabling retrieval further comprises enabling retrieval of the media content based in part on analyzing the angle of view information.

3. The method of claim 2, further comprising:
detecting one or more motion measurements of one or more sensor-enabled devices captured in a field of view of the media capturing device, the motion measurements indicating motion of the objects; and
associating the motion measurements with the context data associated with the media content.

4. The method of claim 3, further comprising:
designating at least one segment of a video, among the videos, as interesting based at least in part on the detected motion of the sensor-enabled devices.

5. The method of claim 4, further comprising:
determining that the motion of the objects comprises rhythmical movements that indicate a corresponding segment of the video is of interest to a user.

6. The method of claim 3, further comprising:
obtaining sensor measurements periodically, according to a specific sampling rate, from the sensor-enabled devices in the field of view of the media capturing device;
evaluating in successive temporal segments an amplitude frequency response of the sensor measurements; and
determining that the object is performing a movement that is interesting in response to identifying a maximum amplitude response associated with the temporal segments in an instance in which the maximum amplitude response is within a predefined frequency range.

7. The method of claim 3, further comprising:
analyzing motion of the objects or motion of the sensor-enabled devices based in part on evaluating one or more different segments of the video and the motion measurements of the sensor-enabled devices;
determining a correlation between the motion of the objects or the motion of the sensor-enabled devices of the different segments and the motion measurements; and
determining, with a high confidence, that the video comprises at least one segment of interest based in part on determining that a value of the correlation is above a predetermined threshold.

8. The method of claim 3, further comprising:
analyzing motion of the objects or motion of the sensor-enabled devices based in part on evaluating one or more different segments of the video and the motion measurements of the sensor-enabled devices;
determining a correlation between the motion of the objects or the motion of the sensor-enabled devices of the different segments and the motion measurements; and
determining a low confidence that the video comprises at least one segment of interest based in part on determining that a value of the correlation is below a predetermined threshold.

9. The method of claim 3, further comprising:
determining that the video comprises at least one segment of interest in response to detecting a high correlation between the motion of the objects, motion identified in the video and musical rhythm detected from audio content associated with data of the video.

10. An apparatus comprising:
at least one processor; and
at least one memory including computer program code, the at least one memory and the computer program code configured to, with the at least one processor, cause the apparatus to perform at least the following:
capture one or more items of media content comprising one or more objects;
assign context data indicating at least one determined location of at least one of the captured objects and a time that the object was captured to the media content;
assign a detected item of orientation information indicating an orientation of a media capturing device capturing the objects to the context data associated with the media content; and
enable retrieval of the media content from a memory based in part on analyzing the location of the captured object, the time and the orientation information.

11. The apparatus of claim 10, wherein the media content comprises one or more images, one or more videos or one or more segments of a video captured during an event and the at least one memory and the computer program code are further configured to, with the processor, cause the apparatus to:
detect an angle of view in which the media capturing device capture the object;
assign data, indicating the angle of view, to the context data associated with the media content; and
enable retrieval by enabling retrieval of the media content based in part on analyzing the angle of view information.

12. The apparatus of claim 11, wherein the at least one memory and the computer program code are further configured to, with the processor, cause the apparatus to:
detect one or more motion measurements of one or more sensor-enabled devices captured in a field of view of the media capturing device, the motion measurements indicating motion of the objects; and
associate the motion measurements with the context data associated with the media content.

13. The apparatus of claim 12, wherein the at least one memory and the computer program code are further configured to, with the processor, cause the apparatus to:
designate at least one segment of a video, among the videos, as interesting based at least in part on the detected motion of the sensor-enabled devices.

14. The apparatus of claim 13, wherein the at least one memory and the computer program code are further configured to, with the processor, cause the apparatus to:
determine that the motion of the objects comprises rhythmical movements that indicate a corresponding segment of the video is of interest to a user.

15. The apparatus of claim 12, wherein the at least one memory and the computer program code are further configured to, with the processor, cause the apparatus to:
obtain sensor measurements periodically, according to a specific sampling rate, from the sensor-enabled devices in the field of view of the media capturing device;
evaluate in successive temporal segments an amplitude frequency response of the sensor measurements; and
determine that the object is performing a movement that is interesting in response to identifying a maximum amplitude response associated with the temporal segments in an instance in which the maximum amplitude response is within a predefined frequency range.

16. The apparatus of claim 12, wherein the at least one memory and the computer program code are further configured to, with the processor, cause the apparatus to:
analyze motion of the objects or motion of the sensor-enabled devices based in part on evaluating one or more different segments of the video and the motion measurements of the sensor-enabled devices;
determine a correlation between the motion of the objects or the motion of the sensor-enabled devices detected in the different segments and the motion measurements; and
determine, with a high confidence, that the video comprises at least one segment of interest based in part on determining that a value of the correlation is above a predetermined threshold.

17. The apparatus of claim 12, wherein the at least one memory and the computer program code are further configured to, with the processor, cause the apparatus to:
analyze motion of the objects or motion of the sensor-enabled devices based in part on evaluating one or more different segments of the video and the motion measurements of the sensor-enabled devices;
determine a correlation between the motion of the objects or the motion of the sensor-enabled devices detected in the different segments and the motion measurements; and
determine a low confidence that the video comprises at least one segment of interest based in part on determining that a value of the correlation is below a predetermined threshold.

18. The apparatus of claim 12, wherein the at least one memory and the computer program code are further configured to, with the processor, cause the apparatus to:
determine that the video comprises at least one segment of interest in response to detecting a high correlation between the motion of the objects, motion identified in the video and musical rhythm detected from audio content associated with data of the video.

19. A method comprising:
receiving one or more captured items of media content comprising one or more objects from one or more media capturing devices of one or more corresponding sensor-enabled devices;
assigning context data indicating one or more determined locations of the captured objects and times that the objects were captured to corresponding items of the media content;
assigning corresponding detected items of orientation information indicating respective orientations of the media capturing devices capturing the objects to the context data associated with the media content; and
enabling, via a processor, retrieval of at least one corresponding item of the media content from a memory based in part on analyzing a corresponding determined location of at least one of the captured objects, a corresponding time the object was captured and corresponding orientation information denoting an orientation in which a respective media capturing device captured the object.

20. The method of claim 19, further comprising:
receiving one or more detected motion measurements of the sensor-enabled devices captured in a field of view of the media capturing devices, the motion measurements indicating motion of the objects; and
associating the motion measurements with the context data associated with the media content.

21. The method of claim 20, wherein the media content comprises one or more images or one or more videos captured during at least one event and the method further comprises:
designating at least one segment of a video, among the videos, as interesting based at least in part on the detected motion of the sensor-enabled devices.

22. A method comprising:
receiving one or more captured items of media content comprising one or more objects from one or more media capturing devices of one or more corresponding sensor-enabled devices;
assigning context data indicating one or more determined locations of the captured objects and times that the objects were captured to corresponding items of the media content;
assigning corresponding detected items of orientation information indicating respective orientations of the media capturing devices capturing the objects to the context data associated with the media content; and
enabling, via a processor, retrieval of at least one corresponding item of the media content from a memory based in part on analyzing a corresponding determined location of at least one of the captured objects, a corresponding time the object was captured and corresponding orientation information denoting an orientation in which a respective media capturing device captured the object.

23. The method of claim 22, further comprising:
receiving one or more detected motion measurements of the sensor-enabled devices captured in a field of view of the media capturing devices, the motion measurements indicating motion of the objects; and
associating the motion measurements with the context data associated with the media content.

24. The method of claim 23, wherein the media content comprises one or more images or one or more videos captured during at least one event and the method further comprises:
designating at least one segment of a video, among the videos, as interesting based at least in part on the detected motion of the sensor-enabled devices.

25. A apparatus comprising:
at least one processor; and
at least one memory including computer program code, the at least one memory and the computer program code configured to, with the at least one processor, cause the apparatus to perform at least the following:
receive one or more captured items of media content comprising one or more objects from one or more media capturing devices of one or more corresponding sensor-enabled devices;
assign context data indicating one or more determined locations of the captured objects and times that the objects were captured to corresponding items of the media content;
assign corresponding detected items of orientation information indicating respective orientations of the media capturing devices capturing the objects to the context data associated with the media content; and
enable retrieval of at least one corresponding item of the media content from a memory based in part on analyzing a corresponding determined location of at least one of the captured objects, a corresponding time the object was captured and corresponding orientation information denoting an orientation in which a respective media capturing device captured the object.

26. The apparatus of claim 25, wherein the at least one memory and the computer program code are further configured to, with the processor, cause the apparatus to:
receive one or more detected motion measurements of the sensor-enabled devices captured in a field of view of the media capturing devices, the motion measurements indicating motion of the objects; and
associate the motion measurements with the context data associated with the media content.

27. The apparatus of claim 26, wherein the media content comprises one or more images or one or more videos captured during at least one event and the memory and the computer program code are further configured to, with the processor, cause the apparatus to:
designate at least one segment of a video, among the videos, as interesting based at least in part on the detected motion of the sensor-enabled devices.
